(19) United States
(12) Patent Application Publication
(10) Pub. No.: US 2018/0290868 A1
(43) Pub. Date: Oct. 11, 2018

(54) Portable Hoisting Apparatus

(71) Applicants: David R. Hall, Provo, UT (US); Jerome Miles, Spanish Fork, UT (US); Justin Robinson, Provo, UT (US)

(72) Inventors: David R. Hall, Provo, UT (US); Jerome Miles, Spanish Fork, UT (US); Justin Robinson, Provo, UT (US)

(21) Appl. No.: 15/479,917

(22) Filed: Apr. 5, 2017

(51) Int. Cl. B66D 3/20; B66D 3/26

(52) U.S. Cl. CPC B66D 3/20; B66D 2700/026; B66D 2700/025; B66D 3/26

(57) ABSTRACT

A portable hoisting apparatus is disclosed which, in general, includes a base, multiple legs, and a winch. The legs pivotally connect to the base. The winch includes a drum, a cable, a motor, and a battery. The cable is windably connected to the drum. The motor is coupled to a gear that rotates the drum. The battery is electrically connected to the motor. The battery is located within a battery holder. The battery holder is positioned intermediate the motor and a controller inside the drum.

### BACKGROUND

### Field of the Invention

This invention relates generally to the field of hoists, and more specifically to portable hoists.

### SUMMARY OF THE INVENTION

An invention has been developed in response to present state of the art and, in particular, in response to problems and needs in the art that have not yet been fully solved by currently available systems and methods. Accordingly, a portable hoist apparatus has been developed. Features and advantages of different embodiments of the invention will become more fully apparent from the following description and appended claims, or may be learned by practice of the invention as set forth hereinafter.

A portable hoisting apparatus is disclosed which, in general, includes a base, multiple legs, and a winch. The legs pivotally connect to the base. The winch includes a drum, a cable, a motor, and a battery. The cable is windably connected to the drum. The motor is coupled to a gear that rotates the drum. The battery is electrically connected to the motor. The battery is located within a battery holder. The battery holder is positioned intermediate the motor and a controller inside the drum.

The cable may include a load supporting connector. The load supporting connector may be a hook. The load supporting connector may be a chain. The load supporting connector may be a rope. The load supporting connector may be a truss member.

The legs may include foldable connecting segments. The foldable connecting segments may include segment locks. The legs may include telescoping segments. The telescoping segments may include segment locks. The segment locks may be locking pins. The segment locks may include collets. The telescoping segments may include collet grooves. The legs may include adjustable length segments. The legs may include spiked feet. Each of the legs may include a hydraulic actuator. Each hydraulic actuator may include a motor and a battery.

The portable hoisting apparatus may include a first pulley. The cable may feed through the first pulley. The first pulley may include a load supporting connector. The portable hoisting apparatus may further include a second pulley. The second pulley may be connected to the base. The first pulley and the second pulley may be connected via the cable.

### BRIEF DESCRIPTION OF THE DRAWINGS

A more particular description of the invention briefly described above is made below by reference to specific embodiments. Several embodiments are depicted in drawings included with this application, in which:

FIG. 1A depicts a front view of a portable hoisting apparatus;

FIG. 1B depicts a front view of a winch;

FIG. 1C depicts an exploded front view of a winch with a drum removed;

FIG. 2 depicts a front view of a hoisting apparatus with a chain;

FIG. 3 depicts an embodiment similar to FIG. 2 with a rope;

FIG. 4 depicts an embodiment similar to FIG. 3 with a truss member;

FIG. 5A depicts an embodiment similar to FIG. 1A with folding legs;

FIG. 5B depicts a close-up view of a segment lock;

FIG. 6A depicts an embodiment similar to FIG. 5A, with telescoping legs;

FIG. 6B depicts an embodiment similar to FIG. 5B, with telescoping legs;

FIG. 7A depicts an embodiment similar to FIG. 6A, with locking pins;

FIG. 7B depicts an embodiment similar to FIG. 6B, with locking pins;

FIG. 8 depicts a portable hoisting apparatus with a pulley;

FIG. 9 depicts an embodiment similar to FIG. 8, with multiple pulleys;

FIG. 10 depicts a cut-out view of a leg of a portable hoisting apparatus.

### DETAILED DESCRIPTION

A detailed description of the claimed invention is provided below by example, with reference to embodiments in the appended figures. Those of skill in the art will recognize that the components of the invention as described by example in the figures below could be arranged and designed in a wide variety of different configurations. Thus, the detailed description of the embodiments in the figures is merely representative of embodiments of the invention, and is not intended to limit the scope of the invention as claimed.

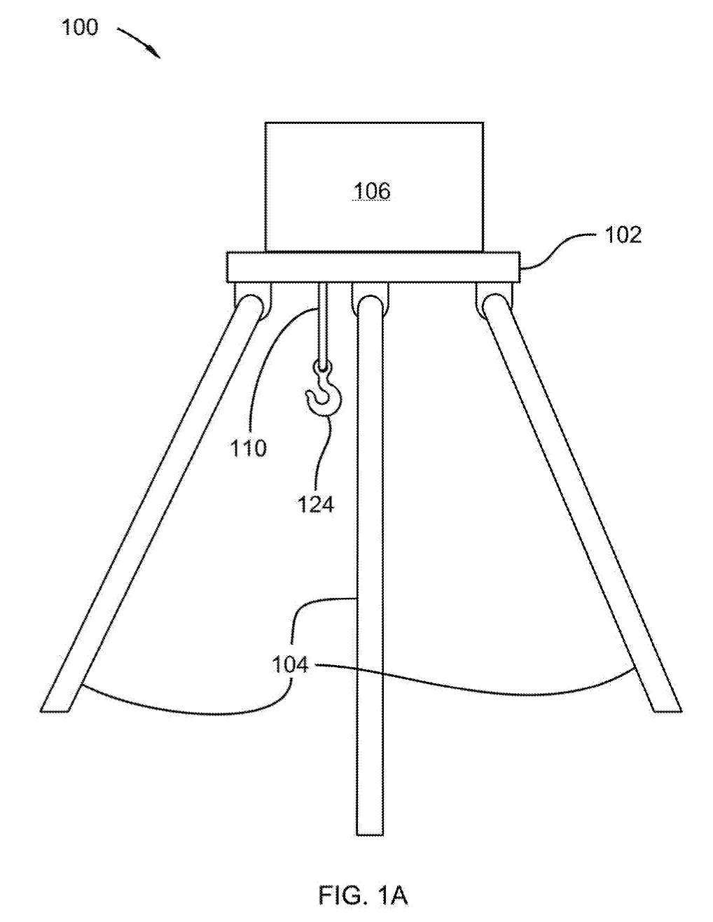

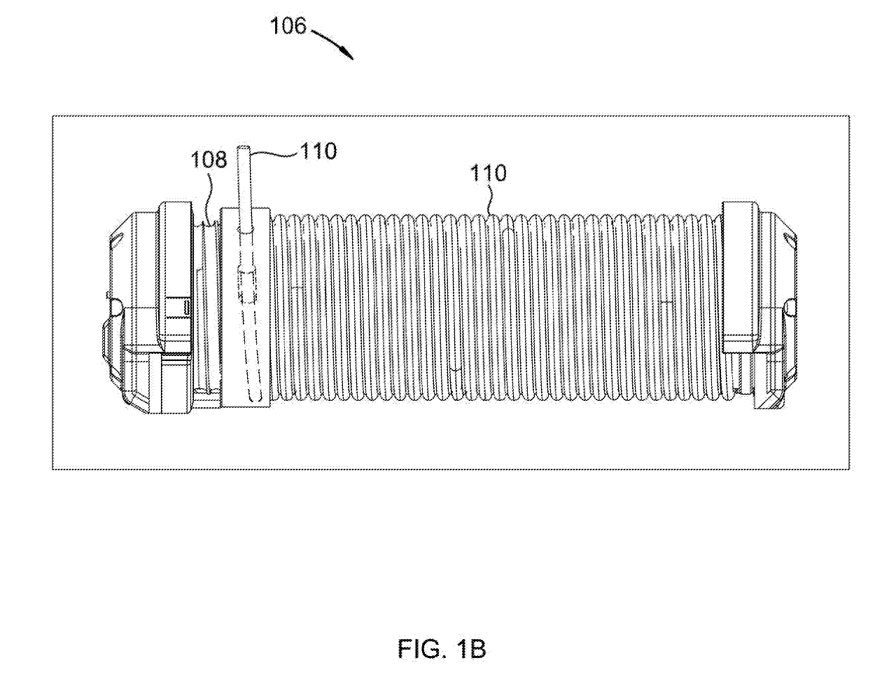

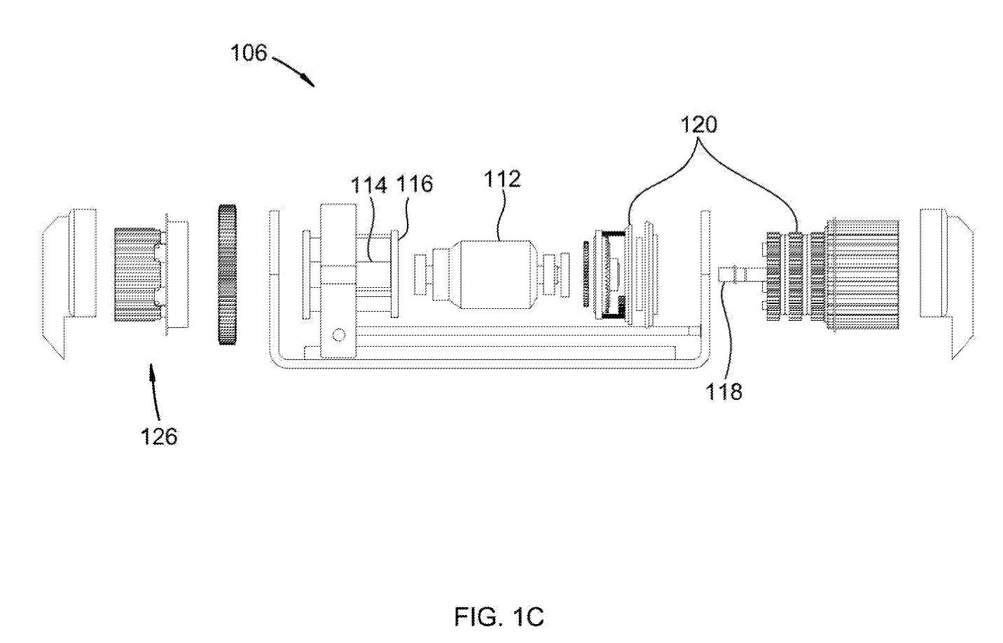

FIG. 1A depicts a front view of a portable hoisting apparatus. FIG. 1B depicts a front view of a winch. FIG. 1C depicts an exploded front view of a winch with a drum removed. Portable hoisting apparatus 100 includes base 102, multiple legs 104, and winch 106. Legs 104 are pivotally connected to base 102. Winch 106 includes drum 108, cable 110, motor 112, and battery 114. Cable 110 is windably connected to drum 108. In other words, cable 110 is connected to and may be wound about drum 108. Motor 112 is coupled to gear assembly 120, and motor 112 rotates drum 108. Battery 114 is electrically connected to motor 112. Battery 114 is located within battery holder 116. Battery holder 116 is positioned intermediate motor 112 and controller 126 inside drum 108.

Legs 104 may pivotally connect to base 102 by any of a variety of pivot joints, including via a ball and socket joint, an ellipsoidal joint, or a pin joint. Motor 112 may connect to battery holder 116. Motor 112 may include axle 118. Axle 118 may connect to motor 112 and gear assembly 120. Gear assembly 120 may connect to drum 108. Cable 110 may include load supporting connector 124. Load supporting connector 124 may be a hook, connected at an end of cable 110.

Motor 112 may draw power from battery 114 to rotate axle 118. Gear assembly 120 may increase torque applied across axle 118 such that drum 108 rotates with a lower angular velocity and higher torque than axel 118. Subsequently, drum 108 may rotate and cable 110 may coil or uncoil, which may allow load supporting connector 124 to raise or lower a load, respectively.

Battery 114 may be fastened to battery holder 116 such that battery 114 is motionless with respect to battery holder 116.

Controller 126 may be electrically connected to motor 112 or battery 114. Controller 126 may receive wireless communications from a peripheral device to control motor 112. For example, a user may send a wireless signal to controller 126 via the peripheral device to raise or lower a load. The peripheral device may be any of a variety of devices, such as a smartphone, a laptop, or a tablet.

Load supporting connector 124 may be coupled to a hook mount corresponding to a load. For example, a wooden pallet may have cargo and a hook mount. Load supporting connector 124 may be coupled to the hook mount such that when winch 106 is actuated, the pallet and its cargo may be lowered or raised.

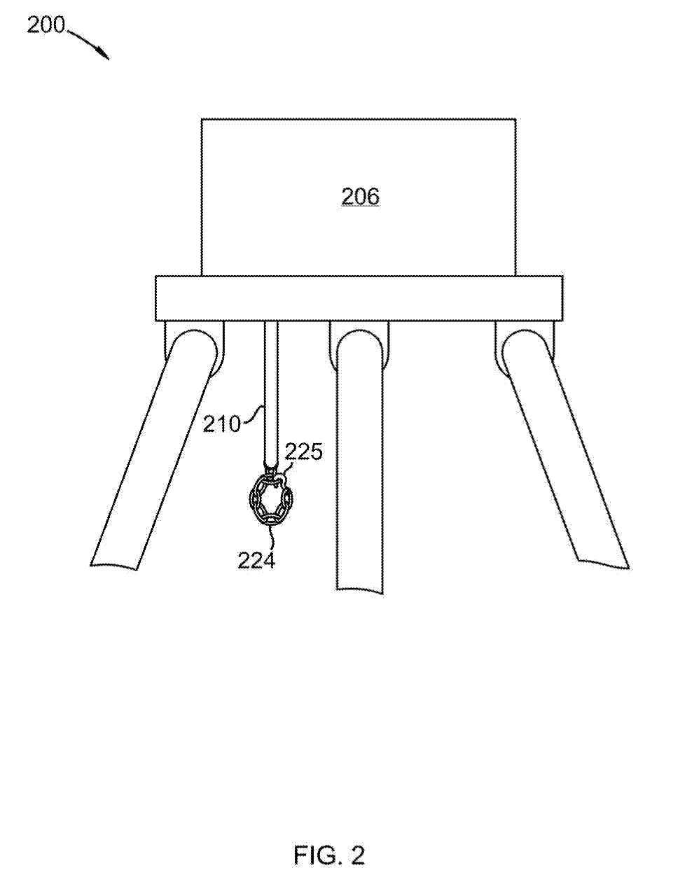

FIG. 2 depicts a front view of a hoisting apparatus with a chain. Cable 210 of portable hoisting apparatus 200 may include chain 224. Chain 224 may include hook 225. Chain 224 may be used to support a load to which is difficult to attach only hook 225, such as a live animal or animal carcass. For example, an animal carcass may be gripped by chain 224 about a head of the animal carcass. Subsequently, winch 206 may raise or lower the animal carcass by coiling or uncoiling cable 210, respectively. Hook 225 may hook onto a link of chain 224 for the purpose of supporting a load.

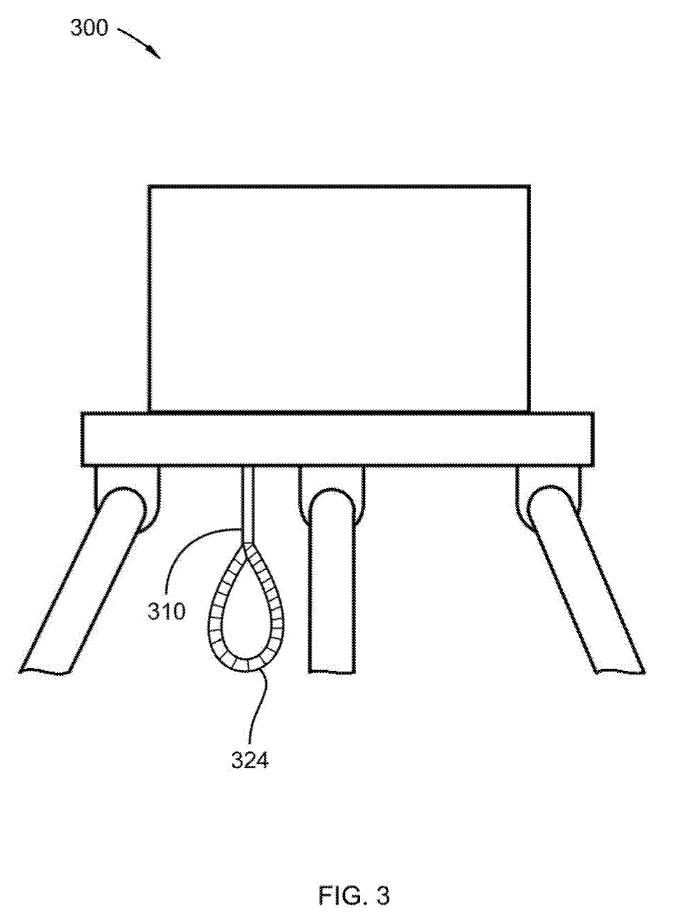

FIG. 3 depicts an embodiment similar to FIG. 2 with a rope. Cable 310 of portable hoisting apparatus 300 may include rope 324. Rope 324 may be used to support a load. Rope 324 may be tied in a knot for attachment to the load.

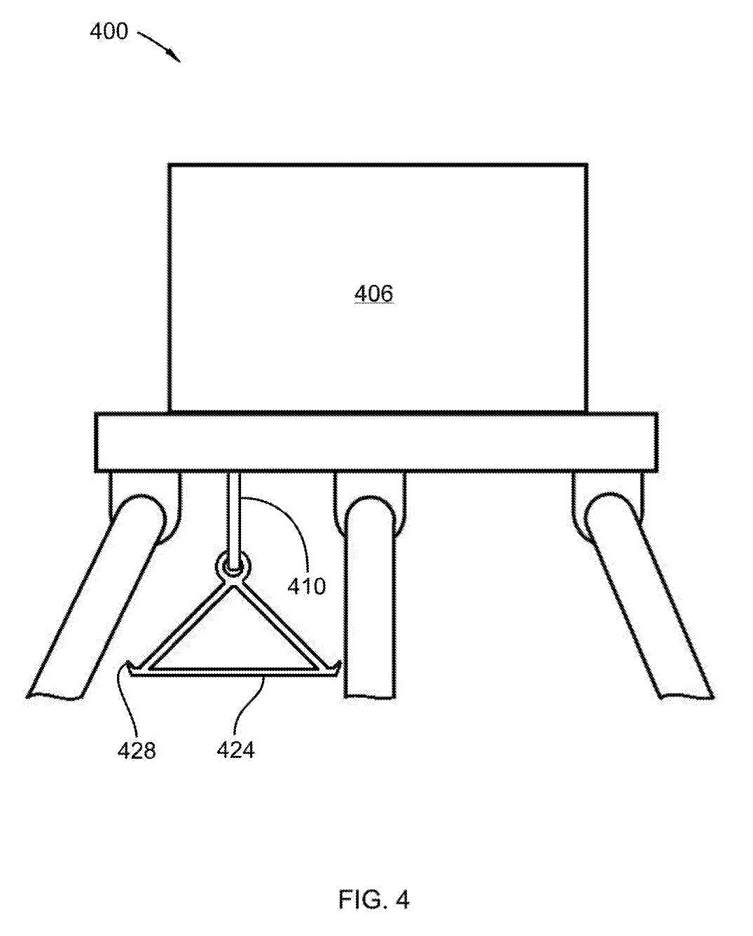

FIG. 4 depicts an embodiment similar to FIG. 3 with a truss member. Cable 410 of portable hoisting apparatus 400 may include truss member 424 (truss meaning a member having a triangular shape which may support a load). Truss member 424 may be made of a variety of materials such as wood, metal, plastic, or composite materials. Truss member 424 may include gambrel spikes 428 (gambrel meaning a joint between tarsal bones and tibia of quadrupedal mammals). Gambrel spikes 428 may be placed in gambrels of a quadrupedal animal to secure the animal to truss member 424. Truss member 424 may subsequently be raised or lowered by winch 406 to raise or lower the animal.

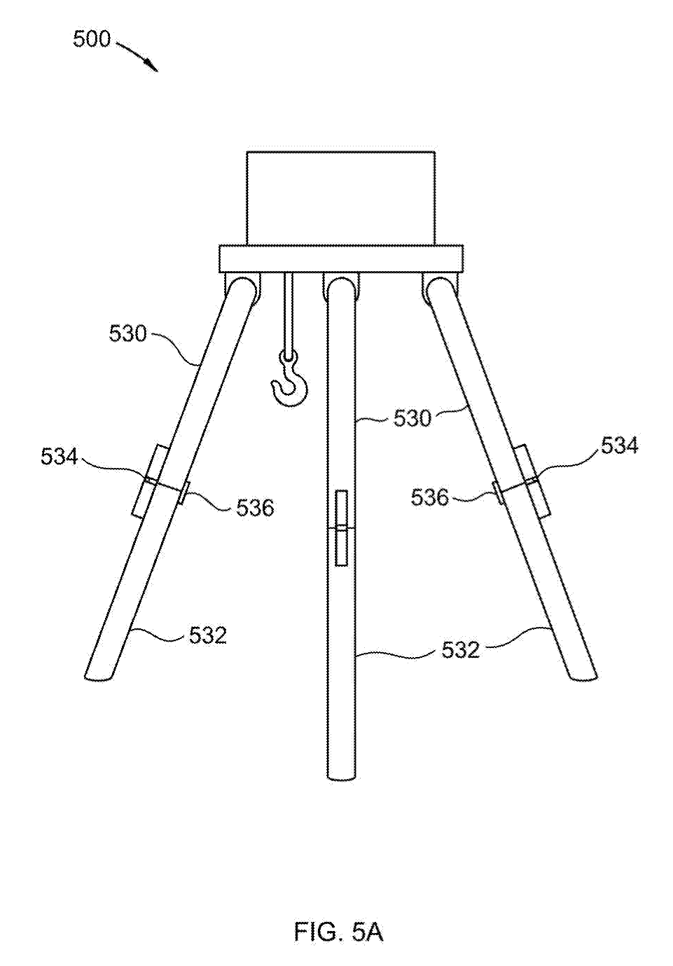

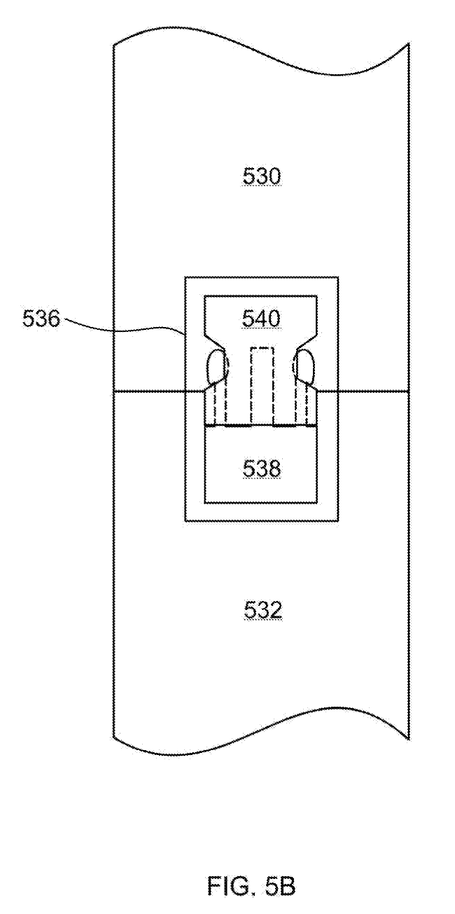

FIG. 5A and FIG. 5B depict an embodiment similar to FIG. 1A with folding legs and a close up view of a segment lock, respectively. Portable hoisting apparatus 500 may include foldable connecting leg segments. The leg segments may include upper segments 530 and lower segments 532. Upper segments 530 may connect with lower segments 532 via pins 534. Lower segments 532 may rotate with respect to upper leg segments 530 and about pins 534 in order to fold or unfold them. Upper segments 530 and lower segments 532 may include segment locks 536. For example, segment locks 536 may include buckles having male buckle segments 538 and female buckle segments 540.

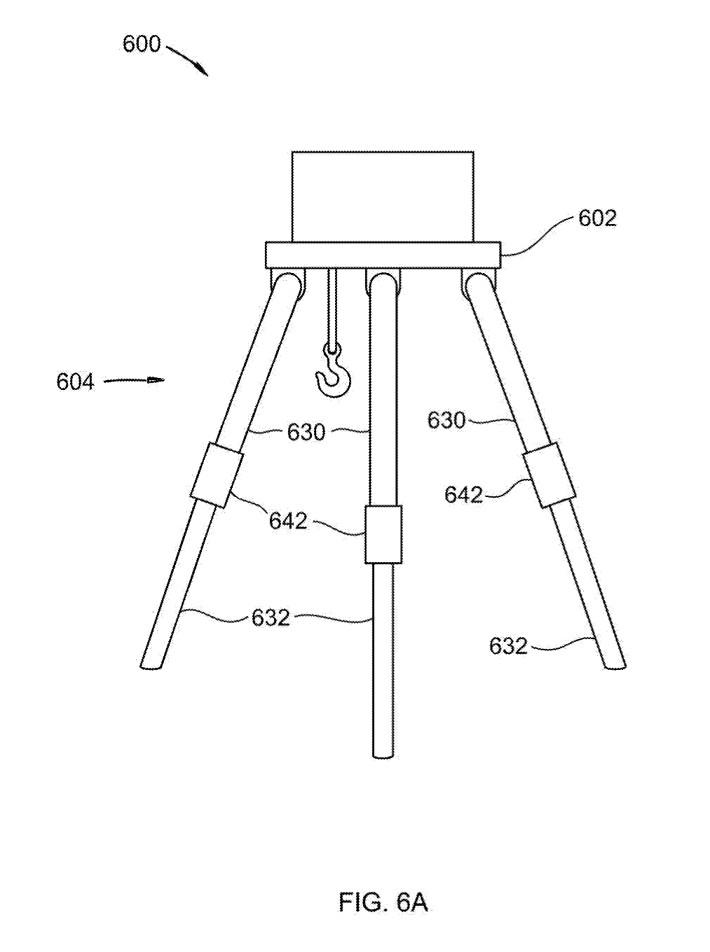

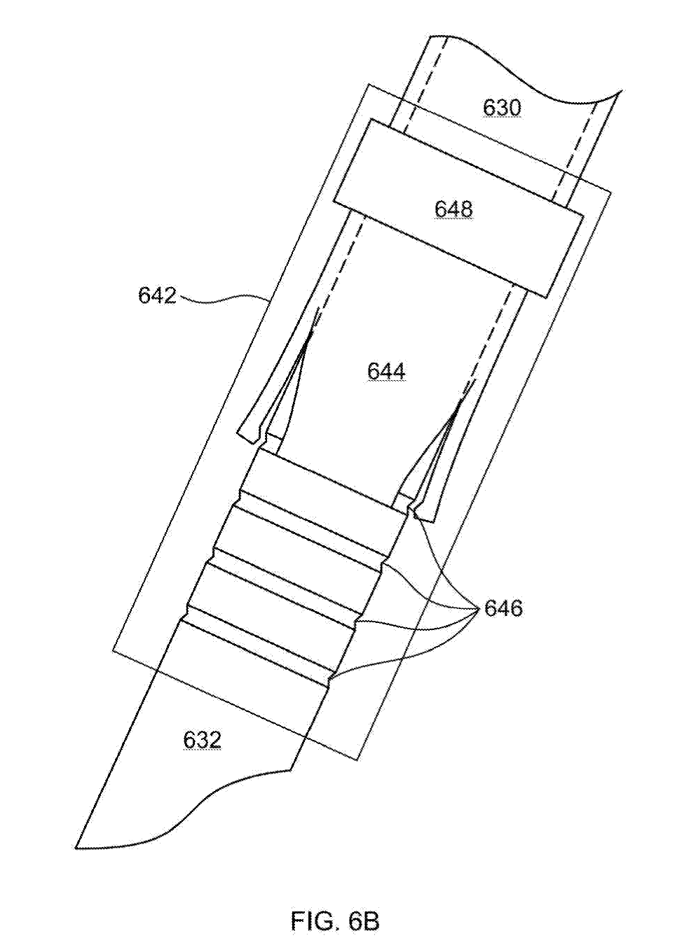

FIG. 6A and FIG. 6B depict embodiments similar to FIG. 5A and FIG. 5B, respectively, with telescoping legs. Legs 604 of portable hoisting apparatus 600 may include telescoping segments. The telescoping segments may include upper segments 630 and lower segments 632. Upper segments 630 and lower segments 632 may include segment locks 642. Segment locks 642 may include collets 644 connected to upper segments 630. Segment locks 642 may also include collet grooves 646 positioned on lower segments 632. Segment locks 642 may also include collet sleeves 648. Collet sleeves 648 and collets 644 may also be threaded.

Upper segments 630 may be concentric with corresponding lower segments 632. Upper segments 630 may be connected to base 602. Lower segments 632 may translate along corresponding concentric axes in order to telescope in or out of upper segments 630. For example, legs 604 may be extended by translating lower segments 632 away from upper segments 630. Segment locks 642 may be subsequently engaged to keep lower segments 632 from translating with respect to upper segments 630.

Segment locks 642 may be engaged by sliding collet sleeves 648 over collets 644 such that a force is developed between collets 644 and corresponding collet sleeves 648. This for may also be developed between collets 644 and collet grooves 646. The developed force may act to lock collets 644 and collet grooves 646 in a same position with respect to each other, preventing respective translation. This lock may also prevent translation between upper segments 630 and lower segments 632.

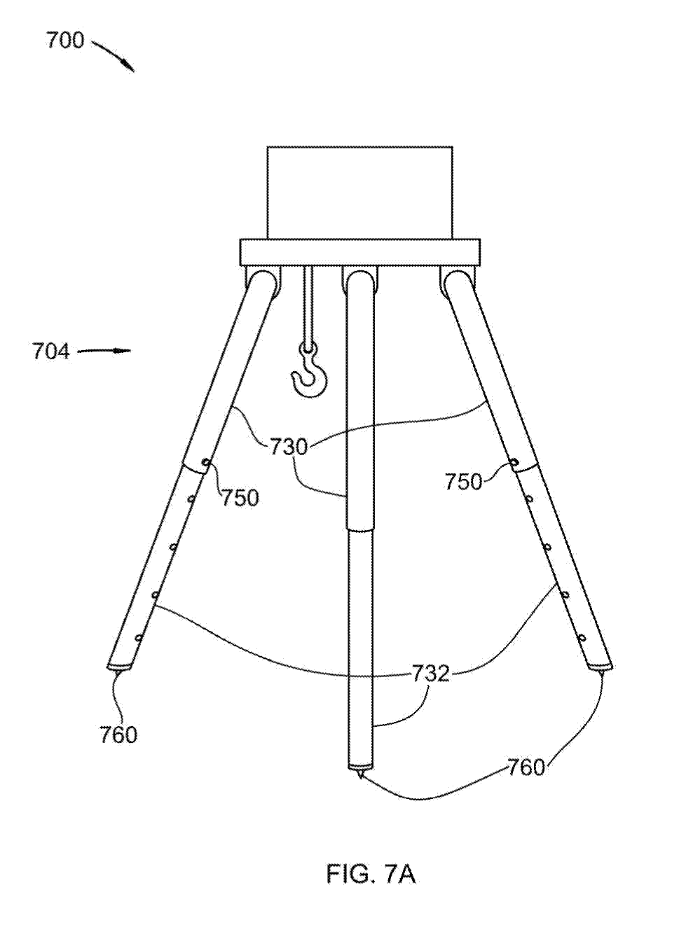

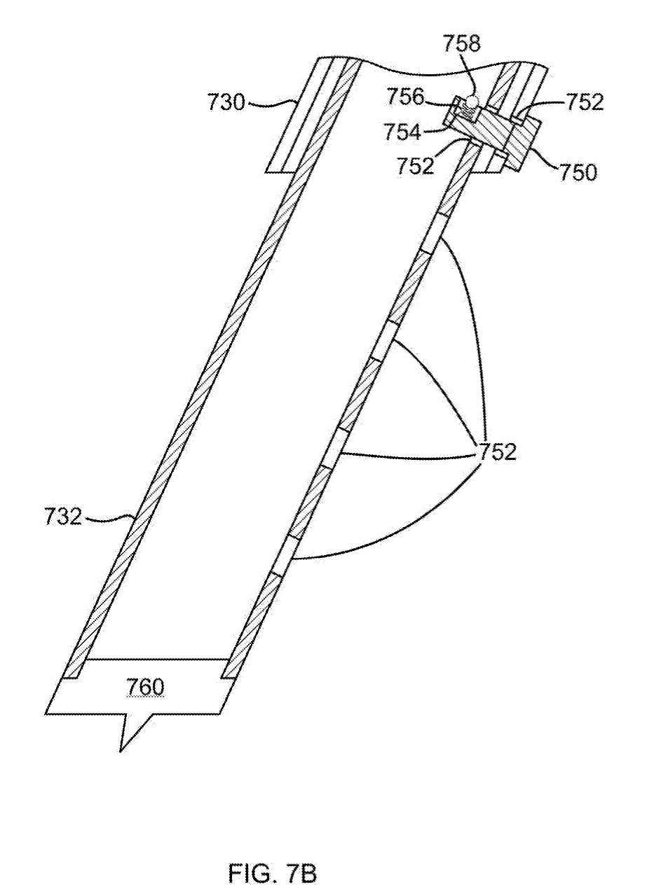

FIG. 7A and FIG. 7B depict embodiments similar to FIG. 6A and FIG. 6B, respectively, with locking pins. Legs 704 of portable hoisting apparatus 700 may include telescoping adjustable length segments. The telescoping segments may include upper segments 730 and lower segments 732. Upper segments 730 and lower segments 732 may include segment locks. The segment locks may be locking pins 750. Upper segments 730 and lower segments 732 may include multiple pin holes 752. Locking pins 750 may be inserted into pin holes 752 in upper segments 730 and lower segments 732 to lock upper segments 730 and lower segments 732 in place. Each of locking pins 750 may include bearing hole 754, spring 756, and ball bearing 758. Spring 756 may be connected to an inside surface of bearing hole 754 and to ball bearing 758. Spring 756 may be connected to an inside surface of bearing hole 754 and to ball bearing 758 by any of a variety of means, including via brazing or welding. Each ball bearing 758 may protrude from surfaces of locking pins 750 in order to prevent locking pins 750 from being unintentionally dislodged from pin holes 752.

Legs 704 may include spiked feet 760. Spiked feet 760 may be inserted into ground in order to prevent legs 704 from slipping.

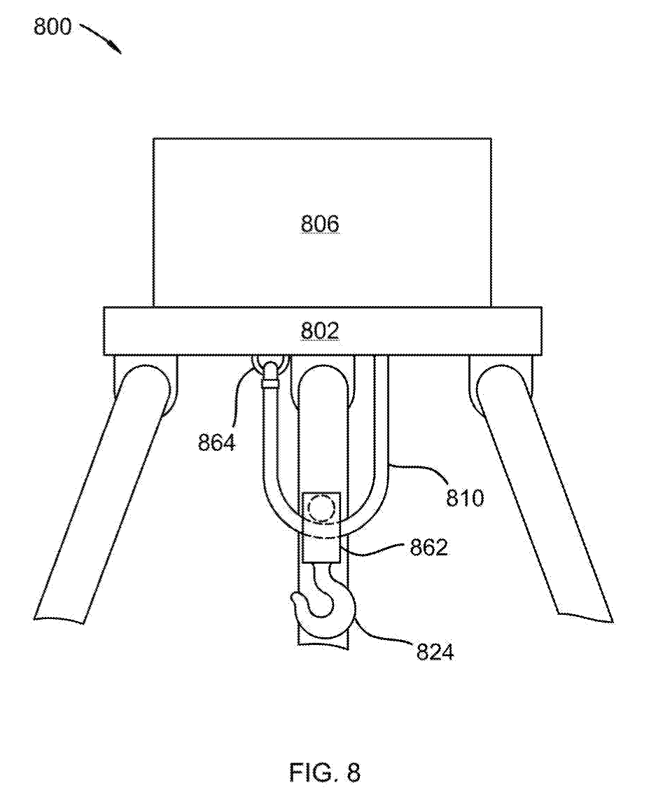

FIG. 8 depicts a portable hoisting apparatus with a pulley. Portable hoisting apparatus 800 may include first pulley 862. Cable 810 may feed through first pulley 862 and connect with mounting ring 864. Mounting ring 864 may be anchored to base 802. First pulley 862 may include load supporting connector 824.

Winch 806 may coil or uncoil cable 810, which may respectively raise or lower pulley 862. For example, load supporting connector 824 may support a load having a weight. The weight of the load may cause tension in cable 810, resulting in a load resisted by both mounting ring 864 and winch 806.

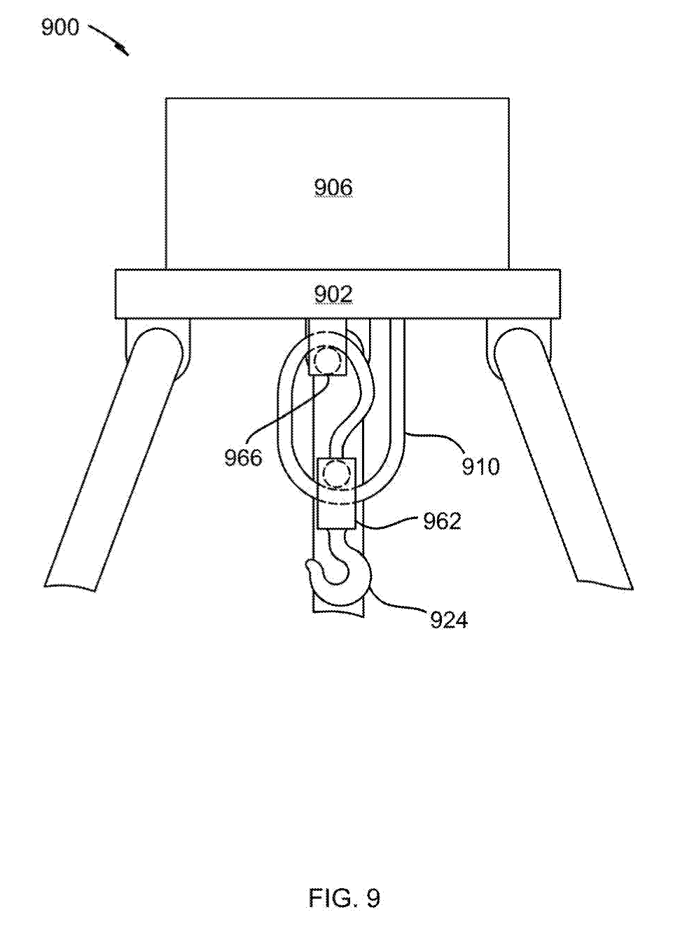

FIG. 9 depicts an embodiment similar to FIG. 8, with multiple pulleys. Portable hoisting apparatus 900 may include first pulley 962 and second pulley 966. Second pulley 966 may be connected to base 902. First pulley 962 and second pulley 966 may be connected via cable 910. Cable 910 may feed through first pulley 962 and second pulley 966. First pulley 962 may include load supporting connector 924.

Winch 906 may coil or uncoil cable 910, which may respectively raise or lower first pulley 962. For example, load supporting connector 924 may support a load having a weight. The weight of the load may cause tension in cable 910, resulting in a load resisted by second pulley 966 and winch 906.

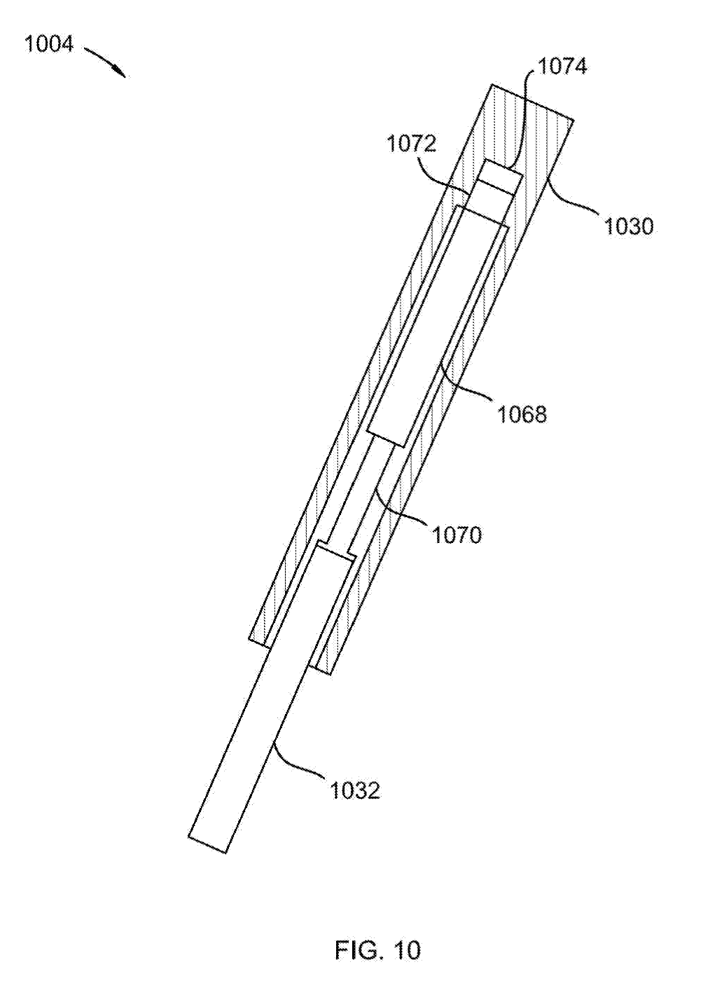

FIG. 10 depicts a cut-out view of a leg of a portable hoisting apparatus. Leg 1004 may include upper segment 1030 and lower segment 1032. Leg 1004 may include hydraulic actuator 1068. Hydraulic actuator 1068 may include piston 1070, motor 1072, and battery 1074. Piston 1070 may be coupled to lower segment 1032. Hydraulic actuator 1068 may be coupled to upper segment 1068. Motor 1072 may draw power from battery 1074 to actuate hydraulic actuator 1072. Subsequently, hydraulic actuator 1068 may extend or retract piston 1070 which may translate lower segment 1032 with respect to upper segment 1030. For example, hydraulic actuator 1068 may be actuated to increase or decrease a sum length of leg 1004. The sum length of leg 1004 being the sum of a length of upper segment 1032 and a length of lower segment 1032 protruding out of upper segment 1030.

1. A portable hoisting apparatus comprising:
a base;
multiple legs pivotally connected to the base;
a winch comprising a drum, a cable windably connected to the drum, a motor coupled to a gear assembly that rotates the drum, and a battery electrically connected to the motor located within a battery holder; and
wherein the battery holder is positioned intermediate the motor and a controller inside the drum.

2. The portable hoisting apparatus of claim 1, wherein the cable comprises a load supporting connector.

3. The portable hoisting apparatus of claim 2, wherein the load supporting connector is a hook.

4. The portable hoisting apparatus of claim 2, wherein the load supporting connector is a chain.

5. The portable hoisting apparatus of claim 2, wherein the load supporting connector is a rope.

6. The portable hoisting apparatus of claim 2, wherein the load supporting connector is a truss member.

7. The portable hoisting apparatus of claim 1, wherein the legs comprise foldable connecting segments.

8. The portable hoisting apparatus of claim 7, wherein the foldable connecting segments further comprise segment locks.

9. The portable hoisting apparatus of claim 1, wherein the legs comprise telescoping segments.

10. The portable hoisting apparatus of claim 9, wherein the telescoping segments comprise segment locks.

11. The portable hoisting apparatus of claim 10, wherein the segment locks are locking pins.

12. The portable hoisting apparatus of claim 10, wherein the segment locks comprise collets.

13. The portable hoisting apparatus of claim 12, wherein the telescoping segments include collet grooves.

14. The portable hoisting apparatus of claim 1, wherein the legs comprise adjustable length segments.

15. The portable hoisting apparatus of claim 1, wherein the legs comprise spiked feet.

16. The portable hoisting apparatus of claim 1, further comprising a first pulley, wherein the cable feeds through the first pulley.

17. The portable hoisting apparatus of claim 16, wherein the first pulley comprises a load supporting connector.

18. The portable hoisting apparatus of claim 17, further comprising a second pulley, wherein the second pulley is connected to the base, and wherein the first pulley and the second pulley are connected via the cable.

19. The portable hoisting apparatus of claim 9, wherein the each of the legs comprises a hydraulic actuator.

20. The portable hoisting apparatus of claim 19, wherein each hydraulic actuator comprises a motor and a battery.
